(19) United States
(12) Patent Application Publication
(10) Pub. No.: US 2018/0256926 A1
(43) Pub. Date: Sep. 13, 2018

(54) SMART MASK CAPABLE OF MONITORING AIR QUALITY INHALED BY USER

(71) Applicant: CENTER FOR INTEGRATED SMART SENSORS FOUNDATION, DAEJEON (KR)

(72) Inventors: CHONG MIN KYUNG, DAEJEON (KR); DAE ICK HAN, DAEJEON (KR)

(73) Assignee: CENTER FOR INTEGRATED SMART SENSORS FOUNDATION, DAEJEON (KR)

(21) Appl. No.: 15/580,677

(22) PCT Filed: Jun. 7, 2016
(86) PCT No.: PCT/KR2016/005976

§ 371 Date: May 23, 2018

(30) Foreign Application Priority Data
Jun. 8, 2015 (KR) 10-2015-0080789

(51) Int. Cl. A62B 18/08; A62B 18/02; A62B 18/10; A62B 23/02

(52) U.S. Cl. CPC A62B 18/088; A62B 23/025; A62B 18/10; A62B 18/02

(57) ABSTRACT

Disclosed is a smart mask capable of monitoring air quality, which is inhaled by a user. A smart mask, according to one embodiment of the present invention, comprises: a main body which forms an internal space by being placed on a partial region of a user's face including the nose and mouth; a close contact portion which is formed on the outer circumferential surface of the main body and brings the main body into close contact with the face when the smart mask is worn; a filter part which is formed on the main body to filter outside air and then provide the outside air into the internal space of the main body; and an internal sensor which is formed inside the main body to measure air quality of the internal space.

### TECHNICAL FIELD

Embodiments of the present invention described herein relate to a smart mask, and more particularly, to a smart mask that may prevent fine germs, viruses, and dust from being introduced into the nose or the mouth of a user and may monitor the quality of air introduced into the user through a mask filter.

### BACKGROUND ART

Today, air pollution is becoming more severe as the convenience means of the industries and the cities develops.

The causes of the air pollution are classified into artificial ones such as combustion of fuels and natural ones such as eruptions of volcanoes. The artificial contaminants are discharged due to combustion of fuels, generation of nuclear energy using nuclear power, chemical reactions, physical processes, and vehicles and air planes. The most important causes of the air pollution are various contaminants generated when fuels are burned. Among them, carbon monoxide (CO), nitrogen dioxide (NO₂), sulfur dioxide (SO₂), and the like occupy the high ratios. In particular, sulfur dioxide (SO₂) reacts with other atmospheric contaminants and generates additional secondary contaminants. The atmospheric contaminants may be classified into gaseous matters such as sulfur dioxide or carbon monoxide and particulate matters such as dust according to the size of the particles. Further, the atmospheric contaminants are often classified into primary contaminants and secondary contaminants according to the generation processes. The primary contaminants refer to contaminants that are directly emitted from a contaminant generation source. For example, the primary contaminants include exhausts generated through combustion of coal and petroleum, dust emitted from cement factories, and sulfur oxides emitted from exhaust pipes of vehicles. The secondary contaminants refer to contaminants that are generated after the primary contaminants are converted into other materials in the air through physical and chemical reactions. Examples of the secondary contaminants include oxidizing agents which are generated after hydrocarbon and nitrogen composites discharged from vehicles or factories undergo photochemical reactions due to ultraviolet rays of the sun. Sulfur dioxide is one of sulfur oxides, and is a fire-resisting gas which is easily dissolved in water, has no color, and has toxic smells. Sulfur oxide is present in volcanoes or hot springs and generates sulfur through reactions with hydrocarbon. Sulfur oxide is artificially discharged when the fossil fuels, such as coal or petroleum is burned, the main discharge sources include power plants, heating apparatuses, metal smelting factories, refineries, and other industrial factories. Carbon monoxide is a toxic gas with no color and no odor, and is generated when carbon in fuels is incompletely burned. The discharge sources of carbon dioxide are mainly vehicles, and also include fuel combustion of the factories, natural causes such as fires, and interior causes such as kitchens, smokes of cigarettes, and local heaters. Carbon dioxide is a reddish brown reactive gas, and is generated through oxidation of nitrogen monoxide in the air and functions as a precursor that generates ozone through reaction with volatile organic composites in the air. The main discharge sources of carbon dioxide include vehicles, high-temperature combustion processes, chemical manufacturing processes, and natural phenomena generated by germs in the soil. Ozone is a material that is generated through photochemical reactions of NOx discharged into the air and volatile organic composites with ultraviolet rays and pertains to secondary contaminants. The volatile organic composites that are precursors are generated from various discharge sources, such as vehicles, industrial facilities including chemical factories and refineries, and natural causes. Currently, 61 composites including carbon monoxide, ammonia, nitrogen oxides, and sulfur oxides are designated as atmospheric contaminants. Among the atmospheric contaminants, materials that may directly or indirectly do harmful to the health or properties of human beings or growth of animals and plants are designated as specific atmospheric contaminants. Currently, 35 composites including dioxin, benzene, carbon tetrachloride, and formaldehyde are designated as the specific atmospheric contaminants.

Yellow sands, dust wind, pollens, germs in the air, forest fires, and eruptions of volcanoes are also the main causes of the air pollution and threat the heath of human beings. Beijing of China and Sumatra of Indonesia are in situations in which the fields of view cannot be secured for more than 30 days per year due to overconsumptions of fossil fuels and production of palm oil, which also badly influences the neighboring cities of other countries, and in many cities of the Southeast Asia, it is impossible to walk on the streets without masks due to the soot and smoke of motorcycles and vehicles. Further, air pollutions in construction sites, cleaning fields, specific material manufacturing factories, painting factories, and hospitals are more serious. People wears masks on their faces when they are in the industrial fields or do sport activities to avoid the contaminated air.

Fires of buildings or facilities due to mistakes or earthquakes, fires of vehicles or trains in tunnels, or toxic gases generated in the agricultural or production fields may immediately take the lives of human beings.

### DETAILED DESCRIPTION OF THE INVENTION

### Technical Problem

Embodiments of the present invention provide a smart mask that may prevent fine germs, viruses, and dust from being introduced into the nose or mouth of a user and may monitor the quality of air introduced into the user through a mask filter.

Embodiments of the present invention also provide a smart mask that may measure the quality of air in the interior of the mask and provide a user with information on the measured quality of the air and may provide the user with a degree of the quality of air and a necessity of exchange of a filter.

Embodiments of the present invention also provide a monitoring system that may monitor information on the quality of air in the interior of a smart mask measured by the smart mask and information on a necessity of exchange of a filter through a user terminal.

### Technical Solution

In accordance with an aspect of the present invention, there is provided a smart mask including a body seated in a partial area of the face of the user including the mouth and the nose and configured to form an interior space, an attachment part formed on an outer peripheral surface of the body and configured to attach the body to the face of the user, a filter part formed in the body and configured to filter exterior air and provide the filtered exterior air to the interior space of the body, and an internal sensor formed in the interior of the body and configured to measure the quality of air in the interior space.

The smart mask may further include a data processing part configured to process data measured through the internal sensor, and a display part configured to display information based on the processed data.

The smart mask may further include an external sensor formed outside the body and configured to measure the quality of exterior air of the body, the data processing part may compare and analyze data measured by the internal sensor and the external sensor, and the display part may display information corresponding to the comparison/analysis result.

The display part may display any one of a plurality of air quality grades based on the processed data or display information on exchange of the filter part.

The smart mask may further include a wireless communication part configured to transmit data measured by the internal sensor to a predetermined external terminal.

The body may be formed of a transparent material or a material to which an anti-fog function is applied.

A material having an anti-fog coating, a nano-size particle layer, or a surface machined into sizes of nano particles may be formed in the body.

The attachment part may be formed of a shape memory resin that contracts due to the temperature of skin if it contacts the skin and is formed of a flexible and elastically deformable resin according to the muscle or skeleton of the face of the user.

The attachment part may have a bent shape for preventing introduction and discharge of air.

The smart mask may further include an air circulation means formed inside or outside the filter part and configured to circulate air.

The smart mask may further include a discharge valve configured to discharge exhaling air of the user through a valve hole, and the discharge valve may be elastically deformed to open the valve hole when the user exhales and interrupt the valve hole when the user inhales.

The smart mask may further include an intake valve configured to suction inhaling air of the user through a valve hole, and the intake valve may be formed inside the filter part on an inner surface of the body and is elastically deformed to open the valve hole when the user inhales and interrupt the valve hole when the user exhales.

In accordance with another aspect of the present invention, there is provided an air quality monitoring system including a mask configured to measure the quality of interior air and transmit data on the measured quality of the air, and a terminal configured to receive the data transmitted by the mask and display information on the quality of the interior air.

The mask may include a body seated in a partial area of the face of the user including the mouth and the nose and configured to form an interior space, a filter part formed in the body and configured to filter exterior air and provide the filtered exterior air to the interior space of the body, an internal sensor formed in the interior of the body and configured to measure the quality of air in the interior space, and a wireless communication part configured to transmit data measured through the internal sensor to the terminal.

The terminal may provide predetermined notification information if data on the measured quality of air is a predetermined reference value or more.

### Advantageous Effects of the Invention

According to embodiments of the present invention, a user may directly feel the effect of a mask by preventing fine germs, viruses, and dust from being introduced into the nose or mouth of a user and monitoring the quality of air introduced into the user through a mask filter.

According to embodiments of the present invention, a user may be provided with a degree of the quality of air and a necessity of exchange of a filter by providing a user with information on the measured quality of the air in the interior of the mask.

In detail, the present invention may digitalize and display information on the measured quality of air in the interior of the mask, and may display a degree of the quality of air and a necessity of exchange of a filter by using a light emitting unit such as an LED.

Further, according to embodiments of the present invention, information on the quality of air in the interior of a smart mask measured by the smart mask and information on a necessity of exchange of a filter may be monitored through a user terminal or notification information related to the quality of air or the mask may be provided.

### DESCRIPTION OF THE DRAWINGS

FIG. 1 illustrates an exemplary view of a state in which a smart mask is mounted according to an embodiment of the present invention;

FIG. 2 illustrates a front view, a rear view, and a left side view of the smart mask according to the embodiment of the present invention;

FIG. 3 illustrates an example of a sectional view of a periphery of the smart mask;

FIG. 4 illustrates a configuration of the smart mask according to the embodiment of the present invention;

FIG. 5 illustrates a configuration of the smart mask according to another embodiment of the present invention; and

FIG. 6 illustrates a configuration of an air quality monitoring system according to an embodiment of the present invention.

### BEST MODE

Hereinafter, embodiments of the present invention will be described with reference to the accompanying drawings. The limited embodiments will be described hereinbelow, but the embodiments are examples of the present invention and the embodiments may be easily changed.

Masks are mounted on the head or the faces of users to prevent dust, fine dust, or chemicals, which may be suctioned in everyday lives, from being suctioned by the users, or to prevent harmful substances such as airborne particles or dust, which are generated in various industrial fields such as factories or construction sites, from being suctioned by the users to shield the mouths and noses of the users, and the essence of the smart mask according to the embodiments of the present invention is to provide a user with a quality degree of the interior air of the smart mask, a necessity of exchange of a filter, and the like based on information on the measured quality of the air in the interior of the smart mask.

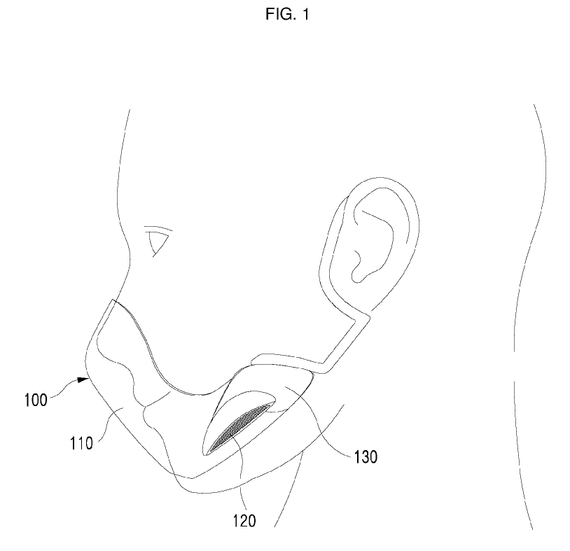

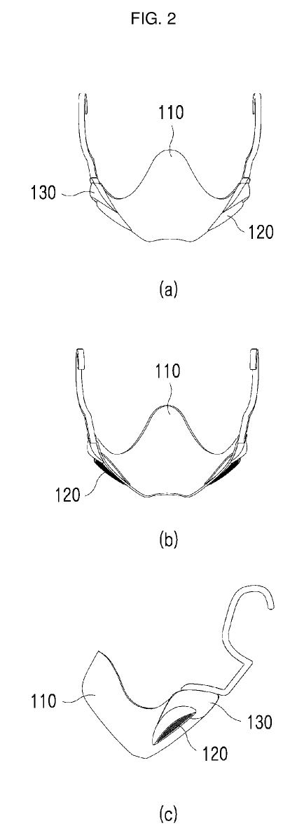

FIG. 1 illustrates an exemplary view of a state in which a smart mask is mounted according to an embodiment of the present invention. FIG. 2 illustrates a front view (a), a rear view (b), and a left side view (c) of the smart mask according to the embodiment of the present invention.

Referring to FIGS. 1 and 2, the smart mask 100 according to the embodiment of the present invention may include a body 110, a filter part 120, and a sensor 130.

The body 110 is seated in a partial area of the face of the user, including the nose and the mouth, to form an interior space.

Then, the body 110 may be formed of a material, such as a synthetic resin, carbon, or rubber, may be formed of a transparent material such that the facial expression of the user may be viewed, and may be formed of a material, to which an anti-fog function is applied. Further, an anti-fog coating or a nano-size particle layer may be formed in the interior of the body 110, and in particular, a material having an anti-fog coating, a nano-size particle layer, or a surface machined into sizes of nano particles may be formed at a part in contact with an exhalation part of the user in the interior of the body.

As illustrated in FIGS. 1 and 2, the body 110 has an upwardly convex shape such that an upper end of the body shields a nose part of the user, and a front part of the body may have a shape that is convexly protrudes according to the shape of the nose to correspond to the face of the user.

Then, the body 110 may include hook parts that are mounted on the ears of the user to fix the smart mask, and may include an attachment part that is formed on an outer peripheral surface of the body 110 to attach the body to the face of the user when the smart mask is mounted on the face of the user.

Of course, the attachment part may be a part of the body, or may be formed as a separate configuration to be coupled to the body.

Moreover, the body 110 may have a discharge valve that discharges the exhaling air through a valve hole according to situations, and the discharge valve may be elastically deformed when the user exhales to open the valve hole and may interrupt the valve hole when the user inhales.

That is, the body 110 discharges the exhaling air to the outside as a discharge valve is formed at a part at which the exhaling air contacts the interior of the body such that the valve is automatically opened when the user exhales, and prevents the exterior air from being introduced as the valve is automatically closed when the user inhales.

Moreover, an intake valve that suctions the inhaling air of the user through a valve hole inside the filter part 120 of an inner surface of the body according to situations may be formed in the body 110, and the intake valve may be elastically deformed when the user inhales to open the valve hole and may interrupt the valve hole when the user exhales.

The attachment part may be formed of a shape memory resin that contracts due to the temperature of skin if it contacts the skin and may be formed of a flexible and elastically deformable resin according to the muscle or skeleton of the face so that the introduction and discharge of the air may be prevented.

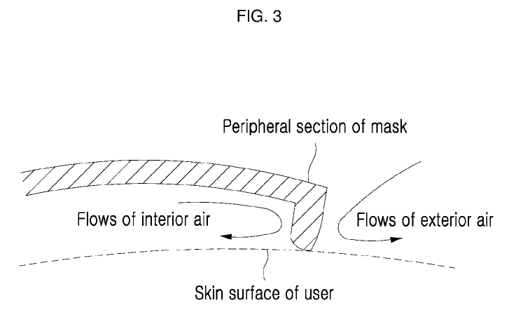

As illustrated in FIG. 3, the attachment part may have a bent shape to prevent the interior air from being discharged to the outside or the exterior air from being introduced into the inside of the body.

The filter part 120 is formed in the body and filters the exterior air and provides the filtered air into the interior space of the body.

That is, the filter part 120 protrudes from a part of the body to filter dust and harmful substances included in the exterior air and provide the filtered exterior air into the interior space of the body.

Then, as illustrated in FIG. 2, the filter part 120 may be formed at a right part (or the right side) and a left part (or the left side) of the smart mask but the present invention is not limited thereto, and the filter part 120 may be formed any one of the right part and the left part or may be formed on a front surface of the body.

Further, the filter part 120 has an air circulation part, for example, an air circulation fan for circulating air in the interior or exterior of the filter part 120.

The sensor, for example, an internal sensor measures the quality of air provided into the interior space of the body through the filter part 120.

Then, the sensor may be formed in the interior of the body, and may include an environment sensor that measures the quality of air or an olfactory sensor that measures the quality of air discharged from the interior of the body of the user through the exhaling air of the user.

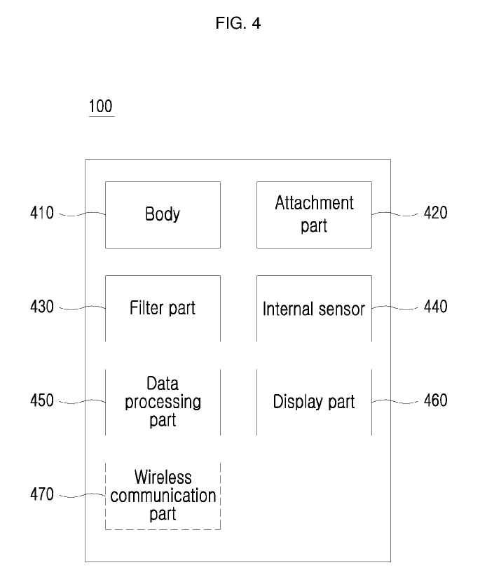

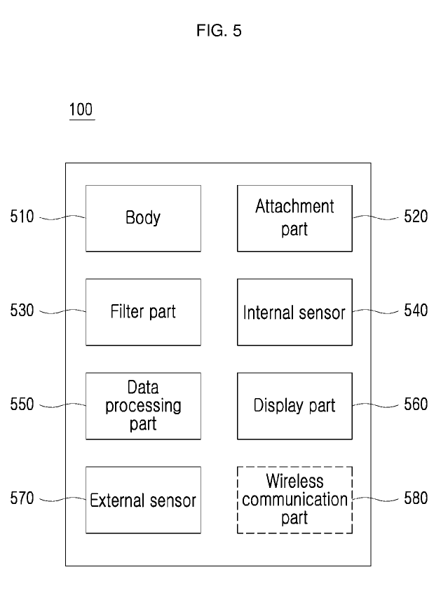

The smart mask according to the embodiment of the present invention may include a means for displaying information on the quality of air measured by a sensor, a means for processing data, and a communication means for communication with an external device, for example, a portable terminal such as a smartphone, which will be described with reference to FIGS. 4 and 5.

FIG. 4 illustrates a configuration of the smart mask according to the embodiment of the present invention.

Referring to FIG. 4, the smart mask 100 according to the embodiment of the present invention includes a body 410, an attachment part 420, a filter part 430, an internal sensor 440, a data processing part 450, a display part 460, and a wireless communication part 470.

The body 410 is seated in a partial area of the face of the user, including the nose and the mouth to form an interior space.

Then, the body 410 may be formed of a material, such as a synthetic resin, carbon, or rubber, may be formed of a transparent material such that the facial expression of the user may be viewed, and may be formed of a material, to which an anti-fog function is applied. Further, an anti-fog coating or a nano-size particle layer may be formed in the interior of the body, and in particular, a material having an anti-fog coating, a nano-size particle layer, or a surface machined into sizes of nano particles may be formed at a part in contact with an exhalation part of the user in the interior of the body.

Then, the body 410 may include an attachment part 420 that is formed on an outer peripheral surface of the body 410 to attach the body to the face of the user when the smart mask is mounted on the face of the user.

Of course, the attachment part 420 may be a part of the body, or may be formed as a separate configuration to be coupled to the body.

Moreover, the body 410 may have a discharge valve that discharges the exhaling air through a valve hole according to situations, and the discharge valve may be elastically deformed when the user exhales to open the valve hole and may interrupt the valve hole when the user inhales.

That is, the body 410 discharges the exhaling air to the outside as a discharge valve is formed at a part at which the exhaling air contacts the interior of the body such that the valve is automatically opened when the user exhales, and prevents the exterior air from being introduced as the valve is automatically closed when the user inhales.

Moreover, an intake valve that suctions the inhaling air of the user through a valve hole inside the filter part 430 of an inner surface of the body according to situations may be formed in the body 410, and the intake valve may be elastically deformed when the user inhales to open the valve hole and may interrupt the valve hole when the user exhales.

The attachment part 420 may be formed of a shape memory resin that contracts due to the temperature of skin if it contacts the skin and may be formed of a flexible and elastically deformable resin according to the muscle or skeleton of the face so that the introduction and discharge of the air may be prevented.

Then, the attachment part 420 may have a bent shape to prevent the interior air from being discharged to the outside or the exterior air from being introduced into the inside of the body 410.

The filter part 430 is formed in the body and filters the exterior air and provides the filtered air into the interior space of the body.

That is, the filter part 430 protrudes from a part of the body to filter dust and harmful substances included in the exterior air and provide the filtered exterior air into the interior space of the body.

The filter part 430 has an air circulation part, for example, an air circulation fan for circulating air in the interior or exterior of the filter part 430.

An internal sensor 440 measures the quality of air provided into the interior space of the body through the filter 430.

Then, the internal sensor 440 may include an environment sensor that measures the quality of air or an olfactory sensor that measures the quality of air discharged from the interior of the body of the user through the exhaling air of the user.

The data processing part 450 analyzes or processes data on the quality of air in the interior space of the body measured by the internal sensor.

Then, the data processing part 450 may compare at least one predetermined standard air quality comparison value and data on the measured quality of air to determine information on the quality of air, for example, a degree of the quality of air or a grade of the quality of air.

The display part 460 is a means for displaying the information on the quality of air analyzed or processed by the data processing part 450, and may be formed in a partial area of the body.

Then, the display part 460 may include a display unit or a light emitting unit, for example, an LED, and may digitalize information on the quality of air to display the digitalized information or may display the information on the necessity of exchange of the filter.

Moreover, the display part 460 may classify the analyzed degree of the quality of air into stages to display the classified degree. For example, the display part 460 may divide the grades of the quality of air into five stages, and may display the grades of the five stages in images or colors.

The wireless communication part 470 is a selective configuration unit, and may be configured according to necessities.

The wireless communication part 470 transmits information on the quality of air analyzed or processed by the data processing part 460 to a predetermined external terminal, for example, a smart phone or the like by using wireless communication.

Then, the wireless communication part 470 may transmit data to the external terminal by using short range wireless communication and Bluetooth or the like as well.

Of course, in this case, the external terminal that receives information on the quality of air has to embed a program that may display or process the information of the quality of air, and the external terminal may visually or audibly provide the user with the information, for example, the grade of the quality of air or a necessity for exchange of the filter.

FIG. 5 illustrates a configuration of the smart mask according to another embodiment of the present invention.

Referring to FIG. 5, the smart mask 100 according to the embodiment of the present invention includes a body 510, an attachment part 520, a filter part 530, an internal sensor 540, a data processing part 550, a display part 560, an external sensor 570, and a wireless communication part 580.

The body 510 is seated in a partial area of the face of the user, including the nose and the mouth, to form an interior space.

Then, the body 510 may be formed of a material, such as a synthetic resin, carbon, or rubber, may be formed of a transparent material such that the facial expression of the user may be viewed, and may be formed of a material, to which an anti-fog function is applied. Further, an anti-fog coating or a nano-size particle layer may be formed in the interior of the body, and in particular, a material having an anti-fog coating, a nano-size particle layer, or a surface machined into sizes of nano particles may be formed at a part in contact with an exhalation part of the user in the interior of the body.

Then, the body 510 may include an attachment part 520 that is formed on an outer peripheral surface of the body 110 to attach the body to the face of the user when the smart mask is mounted on the face of the user.

Of course, the attachment part 520 may be a part of the body, or may be formed as a separate configuration to be coupled to the body.

Moreover, the body 510 may have a discharge valve that discharges the exhaling air through a valve hole according to situations, and the discharge valve may be elastically deformed when the user exhales to open the valve hole and may interrupt the valve hole when the user inhales.

That is, the body 510 discharges the exhaling air to the outside as a discharge valve is formed at a part at which the exhaling air contacts the interior of the body such that the valve is automatically opened when the user exhales, and prevents the exterior air from being introduced as the valve is automatically closed when the user inhales.

Moreover, an intake valve that suctions the inhaling air of the user through a valve hole inside the filter part 530 of an inner surface of the body according to situations may be formed in the body 510, and the intake valve may be elastically deformed when the user inhales to open the valve hole and may interrupt the valve hole when the user exhales.

The attachment part 520 may be formed of a shape memory resin that contracts due to the temperature of skin if it contacts the skin and may be formed of a flexible and elastically deformable resin according to the muscle or skeleton of the face so that the introduction and discharge of the air may be prevented.

Then, the attachment part 520 may have a bent shape to prevent the interior air from being discharged to the outside or the exterior air from being introduced into the inside of the body 510.

The filter part 530 is formed in the body and filters the exterior air and provides the filtered air into the interior space of the body.

That is, the filter part 530 protrudes from a part of the body to filter dust and harmful substances included in the exterior air and provide the filtered exterior air into the interior space of the body.

The filter part 530 has an air circulation part, for example, an air circulation fan for circulating air in the interior or exterior of the filter part 530.

An internal sensor 540 measures the quality of air provided into the interior space of the body through the filter 530.

Then, the internal sensor 540 may include an environment sensor that measures the quality of air or an olfactory sensor that measures the quality of air discharged from the interior of the body of the user through the exhaling air of the user.

The external sensor 570 is formed outside the body 510 to measure the quality of exterior air.

The data processing part 550 analyzes or processes data on the quality of air in the interior space of the body measured by the internal sensor 540 and data on the quality of exterior air measured by the external sensor 570.

Then, the data processing part 550 may analyze a difference between the quality of interior air and the quality of exterior air, and may determine a degree of the quality of exterior air or a necessity of exchange of the filter based on the analysis result.

The display part 560 is a means for displaying the information on the result analyzed or processed by the data processing part 550, and may be formed in a partial area of the body.

Then, the display part 560 may include a display unit or a light emitting unit, for example, an LED, and may digitalize information on the quality of air to display the digitalized information or may display the information on the necessity of exchange of the filter.

Moreover, the display part 560 may classify the analyzed degree of the quality of air into stages to display the classified degree. For example, the display part 560 may divide the grades of the quality of air into five stages, and may display the grades of the five stages in images or colors.

The wireless communication part 580 is a selective configuration unit, and may be configured according to necessities.

The wireless communication part 580 transmits information on the quality of air analyzed or processed by the data processing part 550 to a predetermined external terminal, for example, a smart phone or the like by using wireless communication.

Then, the wireless communication part 580 may transmit data to the external terminal by using short range wireless communication and Bluetooth or the like as well.

Of course, in this case, the external terminal that receives information on the quality of air has to embed a program that may display or process the information of the quality of air, and the external terminal may visually or audibly provide the user with the information.

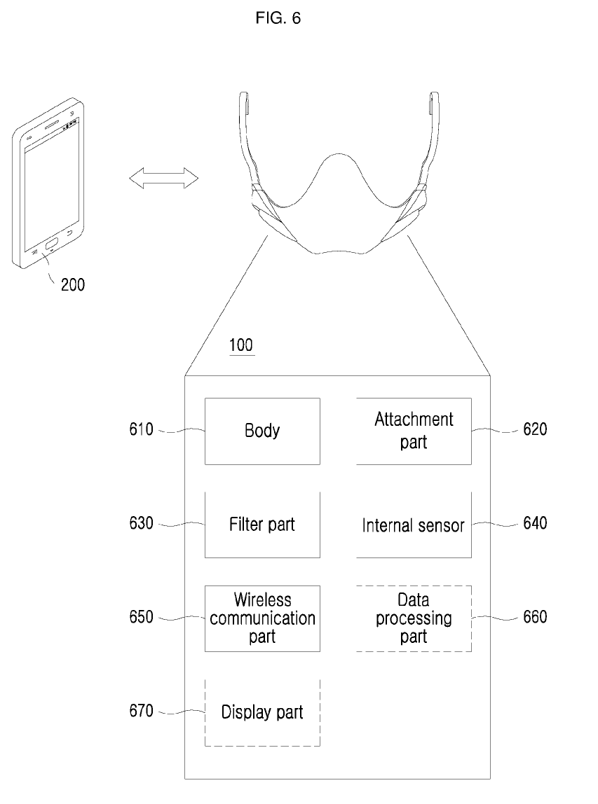

FIG. 6 illustrates a configuration of an air quality monitoring system according to an embodiment of the present invention, and illustrates a monitoring system that performs data processing and display in an external terminal, such as a smartphone.

Referring to FIG. 6, the air quality monitoring system according to the embodiment of the present invention includes a terminal 200 and a smart mask 100.

The smart mask 100 includes a body 610, an attachment part 620, a filter part 630, an internal sensor 640, a wireless communication part 650, a data processing part 660, and a display part 670.

Here, the data processing part 660 and the display part 670 are selective configuration means, and may be provided or may not be provided.

The body 610 is seated in a partial area of the face of the user, including the nose and the mouth, to form an interior space.

Then, the body 610 may be formed of a material, such as a synthetic resin, carbon, or rubber, may be formed of a transparent material such that the facial expression of the user may be viewed, and may be formed of a material, to which an anti-fog function is applied. Further, an anti-fog coating or a nano-size particle layer may be formed in the interior of the body, and in particular, a material having an anti-fog coating, a nano-size particle layer, or a surface machined into sizes of nano particles may be formed at a part in contact with an exhalation part of the user in the interior of the body.

Then, the body 610 may include an attachment part 620 that is formed on an outer peripheral surface of the body 610 to attach the body to the face of the user when the smart mask is mounted on the face of the user.

Of course, the attachment part 620 may be a part of the body, or may be formed as a separate configuration to be coupled to the body.

Moreover, the body 610 may have a discharge valve that discharges the exhaling air through a valve hole according to situations, and the discharge valve may be elastically deformed when the user exhales to open the valve hole and may interrupt the valve hole when the user inhales.

That is, the body 610 discharges the exhaling air to the outside as a discharge valve is formed at a part at which the exhaling air contacts the interior of the body such that the valve is automatically opened when the user exhales, and prevents the exterior air from being introduced as the valve is automatically closed when the user inhales.

Moreover, an intake valve that suctions the inhaling air of the user through a valve hole inside the filter part 630 of an inner surface of the body according to situations may be formed in the body 610, and the intake valve may be elastically deformed when the user inhales to open the valve hole and may interrupt the valve hole when the user exhales.

The attachment part 620 may be formed of a shape memory resin that contracts due to the temperature of skin if it contacts the skin and may be formed of a flexible and elastically deformable resin according to the muscle or skeleton of the face so that the introduction and discharge of the air may be prevented.

Then, the attachment part 620 may have a bent shape to prevent the interior air from being discharged to the outside or the exterior air from being introduced into the inside of the body 610.

The filter part 630 is formed in the body and filters the exterior air and provides the filtered air into the interior space of the body.

That is, the filter part 630 protrudes from a part of the body to filter dust and harmful substances included in the exterior air and provide the filtered exterior air into the interior space of the body.

The filter part 630 has an air circulation part, for example, an air circulation fan for circulating air in the interior or exterior of the filter part 630.

The internal sensor 640 measures the quality of air provided into the interior space of the body through the filter 630.

Then, the internal sensor 640 may include an environment sensor that measures the quality of air or an olfactory sensor that measures the quality of air discharged from the interior of the body of the user through the exhaling air of the user.

The data processing part 650 analyzes or processes data on the quality of air in the interior space of the body measured by the internal sensor.

Then, the data processing part 650 may compare at least one predetermined standard air quality comparison value and data on the measured quality of air to determine information on the quality of air, for example, a degree of the quality of air or a grade of the quality of air.

The display part 670 is a means for displaying the information on the quality of air analyzed or processed by the data processing part 650, and may be formed in a partial area of the body.

Then, the display part 670 may include a display unit or a light emitting unit, for example, an LED, and may digitalize information on the quality of air to display the digitalized information or may display the information on the necessity of exchange of the filter.

Moreover, the display part 670 may classify the analyzed degree of the quality of air into stages to display the classified degree. For example, the display part 670 may divide the grades of the quality of air into five stages, and may display the grades of the five stages in images or colors.

The wireless communication part 650 transmits data on the quality of air measured by the internal sensor to the terminal by using wireless communication.

When the data processing part 660 is provided in the smart mask 100, the wireless communication part 650 may transmit information on the quality of air analyzed or processed by the data processing part to the terminal.

The terminal 200 receives the data transmitted through the wireless communication part 650 of the smart mask 100, and displays the information on the quality of air in the interior of the smart mask based on the received data.

Then, when receiving data measured by the internal sensor through the wireless communication part, the terminal 200 may compare the data on measured quality of air and a predetermined reference value, and may provide the user with predetermined notification information when the data on the quality of air corresponds to a reference value or more.

Here, the notification information may be visual information, may be audible information, and may be information provided by the user through means such as vibration.

Further, it is preferable that the terminal employs a program for providing information on the present invention, and a grade of the quality of air or a necessity for exchange of the filter may be visually or audibly provided to the user by using the employed program.

Further, the terminal and the smart mask may provide the user with information on the quality of air through the terminal by transmitting and receiving data at a specific period, and when receiving the data on the quality of air from the smart mask, the terminal may automatically execute an application related to the present invention and may provide the user with the information on the quality of air.

Although it has been exemplified that only the internal sensor is provided in the smart mask, the monitoring system according to the embodiment of the present invention is not limited to the configuration of FIG. 6 and the smart mask of FIG. 6 may include an internal sensor and an external sensor as in FIG. 5. That is, data measured by the internal sensor and data measured by the external sensor may be transmitted to the terminal through the wireless communication part, and the terminal may process on the grade on the quality of air in the interior of the smart mask or the necessity for exchange of a filter by using the interior air quality information and the exterior air quality information transmitted through the wireless communication part and may provide the user with the result.

Although the present invention has been described with reference to the limited embodiments and the accompanying drawings, the present invention may be variously corrected and modified from the above description by those skilled in the art to which the present invention pertains. For example, the above-described technologies may be carried out in other sequence than the above-described methods, and/or the elements such as the system, the structure, the device, or the circuit may be coupled to or combined with each other in other forms than the above-described method, or may be replaced by other elements or equivalents while achieving the same result.

Therefore, other implementations, other embodiments, and the equivalents to the claims pertain to the scope of the present invention.

### INDUSTRIAL APPLICABILITY

1. A smart mask comprising:
a body seated in a partial area of the face of the user including the mouth and the nose and configured to form an interior space;
an attachment part formed on an outer peripheral surface of the body and configured to attach the body to the face of the user;
a filter part formed in the body and configured to filter exterior air and provide the filtered exterior air to the interior space of the body; and
an internal sensor formed in the interior of the body and configured to measure the quality of air in the interior space.

2. The smart mask of claim 1, further comprising:
a data processing part configured to process data measured through the internal sensor; and
a display part configured to display information based on the processed data.

3. The smart mask of claim 2, further comprising:
an external sensor formed outside the body and configured to measure the quality of exterior air of the body,
wherein the data processing part compares and analyzes data measured by the internal sensor and the external sensor, and
wherein the display part displays information corresponding to the comparison/analysis result.

4. The smart mask of claim 2, wherein the display part displays any one of a plurality of air quality grades based on the processed data or displays information on exchange of the filter part.

5. The smart mask of claim 1, further comprising:
a wireless communication part configured to transmit data measured by the internal sensor to a predetermined external terminal.

6. The smart mask of claim 1, wherein the body is formed of a transparent material or a material to which an anti-fog function is applied.

7. The smart mask of claim 1, wherein a material having an anti-fog coating, a nano-size particle layer, or a surface machined into sizes of nano particles is formed in the body.

8. The smart mask of claim 1, wherein the attachment part is formed of a shape memory resin that contracts due to the temperature of skin if it contacts the skin and is formed of a flexible and elastically deformable resin according to the muscle or skeleton of the face of the user.

9. The smart mask of claim 1, wherein the attachment part has a bent shape for preventing introduction and discharge of air.

10. The smart mask of claim 1, further comprising:
an air circulation means formed inside or outside the filter part and configured to circulate air.

11. The smart mask of claim 1, further comprising:
a discharge valve configured to discharge exhaling air of the user through a valve hole,
wherein the discharge valve is elastically deformed to open the valve hole when the user exhales and interrupt the valve hole when the user inhales.

12. The smart mask of claim 1, further comprising:
an intake valve configured to suction inhaling air of the user through a valve hole,
wherein the intake valve is formed inside the filter part on an inner surface of the body and is elastically deformed to open the valve hole when the user inhales and interrupt the valve hole when the user exhales.

13. An air quality monitoring system comprising:
a mask configured to measure the quality of interior air and transmit data on the measured quality of the air; and
a terminal configured to receive the data transmitted by the mask and display information on the quality of the interior air.

14. The air quality monitoring system of claim 13, wherein the mask includes:
a body seated in a partial area of the face of the user including the mouth and the nose and configured to form an interior space;
a filter part formed in the body and configured to filter exterior air and provide the filtered exterior air to the interior space of the body;
an internal sensor formed in the interior of the body and configured to measure the quality of air in the interior space; and
a wireless communication part configured to transmit data measured through the internal sensor to the terminal.

15. The air quality monitoring system of claim 13, wherein the terminal provides predetermined notification information if data on the measured quality of air is a predetermined reference value or more.
